(19) United States
(12) Patent Application Publication
(10) Pub. No.: US 2014/0087078 A1
(43) Pub. Date: Mar. 27, 2014

(54) PREPARATION METHOD OF YAOBIAN POTTERY

(71) Applicant: ELIX CO., LTD., Muan-gun (KR)

(72) Inventor: Oh Hoon Lee, Mokpo-si (KR)

(73) Assignee: ELIX CO., LTD., Muan-gun (KR)

(21) Appl. No.: 13/689,039

(22) Filed: Nov. 29, 2012

(30) Foreign Application Priority Data
Sep. 21, 2012 (KR) 1020120105200

(51) Int. Cl. B05D 3/02

(52) U.S. Cl. CPC B05D 3/0254
USPC 427/259; 427/379

(57) ABSTRACT

The present disclosure relates to a method for preparing yaobian pottery having different colors at bottom, side and inside portions, yaobian pottery prepared thereby, and a locking-type airtight container using the same.

The method for preparing yaobian pottery according to the present disclosure allows reproduction of regular yaobian patterns and mass production of the yaobian pottery. The locking-type airtight container using the yaobian pottery may be used to store food and food ingredients for a long period of time. The present disclosure provides the effect of maximizing the commercial value of the yaobian pottery which has been esteemed for its aesthetic value.

### CROSS-REFERENCE TO RELATED APPLICATIONS

This application claims priority under 35 U.S.C. §119 to Korean Patent Application Serial No. 10-2012-0105200, filed on Sep. 21, 2012, in the Korean Intellectual Property Office, the disclosure of which is incorporated herein by reference in its entirety.

### TECHNICAL FIELD

The present disclosure relates to a method for preparing yaobian pottery having different colors at different positions, yaobian pottery prepared thereby and a locking-type airtight container using the same. More particularly, the disclosure relates to yaobian pottery having different colors at bottom, side and inside portions and some of which exhibiting yaobian phenomenon, yaobian pottery prepared thereby and a locking-type airtight container using the same.

### BACKGROUND

Pottery refers to products formed by mixing mineral substances such as clay, feldspar, silica, pottery stone, etc. and baked by applying heat. The pottery is classified differently in different countries or by different researchers. In Korea, the pottery is generally classified into porcelain, earthenware, stoneware and clayware.

In general, a process of preparing the pottery can be divided into preparation of the body, shaping, drying, baking, glazing and ornamentation. In general, a glaze, which is a thin layer of a vitreous substance fused to the surface of pottery, is used to reduce water absorption and improve strength of the pottery and decorate the pottery. That is to say, the glaze is coated on the surface of the pottery and fused by heat treatment so as to form a glossy or matte surface layer, which serves to prevent permeation of water, add aesthetic effect and strengthen the pottery.

The term “yaobian” refers to the unexpected change in color, state or shape of the pottery occurring when it is baked in a kiln owing to the properties or states of the flame or glaze, or the pottery resulting thereby. Especially, the term refers to the change in color of the glaze or the pottery resulting thereby. For example, a celadon ware may turn yellowish brown due to oxidation, and a white porcelain may develop black or red spots as iron or copper powder is incorporated into the pottery. The yaobian pottery is esteemed as pottery of high artistic and commercial value owing to the aesthetic sense evoked by the yaobian phenomenon. However, since it is very difficult to reproduce the patterns resulting from the yaobian phenomenon, it is not easy to produce the yaobian pottery in large scale for commercial purposes.

### SUMMARY

The present disclosure is directed to providing a method for preparing yaobian pottery, capable of reproducing yaobian patterns and allowing mass production, and yaobian pottery prepared thereby. The present disclosure is also directed to providing a method for preparing yaobian pottery wherein the colors of the bottom, side and inside portions of the pottery are different from one another owing to the yaobian phenomenon, and yaobian pottery prepared thereby. The present disclosure is also directed to providing a locking-type airtight container using the yaobian pottery, allowing long-term storage of food and food ingredients.

In one general aspect, there is provided a method for preparing yaobian pottery, including:

1) applying a first glaze composition on a surface of the pottery;

2) drying the pottery;

3) applying a second glaze composition, wherein the second glaze composition is different from the first glaze composition, on a surface of the pottery; and

4) baking the pottery.

In another general aspect, there is provided a method for preparing yaobian pottery, including:

1) preparing a first glaze composition and a second glaze composition;

2) applying the first glaze composition only on the side portion of the pottery by immersing the pottery in the first glaze composition up to the upper end of the side portion of the pottery in the state where the bottom portion of the pottery is covered with an impermeable layer and the inside portion of the pottery is fixed;

3) removing the impermeable layer covering the bottom portion of the pottery;

4) drying the pottery;

5) applying the second glaze composition on the whole surface of the pottery by immersing the pottery in the second glaze composition; and

6) baking the pottery.

The first glaze composition may contain 75-85 parts by weight of limestone, 50-55 parts by weight of dolomite, 60-70 parts by weight of wollastonite, 75-85 parts by weight of clay, 30-40 parts by weight of alumina, 45-50 parts by weight of kaolin, 75-85 parts by weight of quartz porphyry, 15-25 parts by weight of graphite, 30-35 parts by weight of pine ash, 70-75 parts by weight of titanium dioxide, 45-50 parts by weight of a pigment, 10-15 parts by weight of bone ash and 30-35 parts by weight of frit, based on 100 parts by weight of feldspar. And, the second glaze composition may contain 15-25 parts by weight of limestone, 20-30 parts by weight of dolomite, 25-35 parts by weight of wollastonite, 70-80 parts by weight of clay, 10-20 parts by weight of pottery stone, 5-15 parts by weight of alumina, 45-55 parts by weight of kaolin, 35-45 parts by weight of quartz porphyry, 20-30 parts by weight of pine ash, 65-75 parts by weight of titanium dioxide, 70-80 parts by weight of a pigment, 20-30 parts by weight of bone ash, 55-65 parts by weight of frit, 10-20 parts by weight of stalactite, 35-45 parts by weight of silica, 10-20 parts by weight of cobalt oxide and 55-65 parts by weight of petalite, based on 100 parts by weight of feldspar. The baking may be performed at 1250-1350° C. In another general aspect, there is provided yaobian pottery prepared by the above-described method for preparing yaobian pottery, which has a yaobian pattern formed on the side portion where the first glaze composition and the second glaze composition are doubly applied.

In another general aspect, there is provided a locking-type airtight container using yaobian pottery including: a body an upper portion of which is open; a lid covering the upper portion; and a locking means coupled to each side portion of the lid, wherein the body has an edge surrounding the outer circumference of the upper portion of the body, the locking means is coupled by a hinge, and the body and the edge are the yaobian pottery the present disclosure. The lid may have a packing for sealing the inside of the body formed on the portion brought into contact with the upper portion of the body when the upper portion is covered. The edge may have a coupling assisting groove for coupling with the locking means formed on the lower portion thereof. The locking means may include a coupling rack for coupling with the coupling assisting groove.

The method for preparing yaobian pottery according to the present disclosure allows reproduction of yaobian patterns and mass production. The yaobian pottery prepared by the method according to present disclosure has different colors at side and inside portions of the pottery. The locking-type airtight container using yaobian pottery according to present disclosure allows long-term storage of food and food ingredients. The present disclosure provides the effect of maximizing the commercial value of the yaobian pottery which has been esteemed for its aesthetic value. Other features and aspects will be apparent from the following detailed description, drawings and claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 describes a process of applying a first glaze composition;

FIG. 2 describes a process of applying a second glaze composition;

FIG. 3 is a photograph of yaobian pottery prepared according to an exemplary embodiment of the present disclosure;

FIG. 4 is a photograph of yaobian pottery prepared according to an exemplary embodiment of the present disclosure;

FIG. 5 is a photograph of yaobian pottery prepared according to an exemplary embodiment of the present disclosure;

FIG. 6 is a photograph of yaobian pottery prepared according to an exemplary embodiment of the present disclosure;

FIG. 7 is a photograph of yaobian pottery prepared according to an exemplary embodiment of the present disclosure;

FIG. 8 shows photographs of yaobian pottery prepared according to an exemplary embodiment of the present disclosure taken from different angles;

FIG. 9 is a photograph of yaobian pottery prepared using a glaze composition prepared in Comparative Example 1;

FIG. 10 is a photograph of yaobian pottery prepared using a glaze composition prepared in Comparative Example 2;

FIG. 11 is a photograph of yaobian pottery prepared using a glaze composition prepared in Comparative Example 3;

FIG. 12 is a photograph of yaobian pottery prepared using a glaze composition prepared in Comparative Example 4;

FIG. 13 shows a locking-type airtight container according to the present disclosure in a state wherein a lid is coupled with a body;

FIG. 14 is a side cross-sectional view of a locking-type airtight container according to the present disclosure in a state wherein a lid is coupled with a body;

FIG. 15 shows the portion of a lid of a locking-type airtight container according to the present disclosure which is coupled with a body; and

FIG. 16 is a photograph of a locking-type airtight container according to the present disclosure.

### DETAILED DESCRIPTION OF MAIN ELEMENTS

100: locking-type airtight container using yaobian pottery
200: body
300: lid
400: locking means
500: edge
600: hinge
700: packing
800: coupling assisting groove
900: coupling rack

It should be understood that the appended drawings are not necessarily to scale, presenting a somewhat simplified representation of various preferred features illustrative of the basic principles of the disclosure. The specific design features of the disclosure as disclosed herein, including, for example, specific dimensions, orientations, locations and shapes, will be determined in part by the particular intended application and use environment. In the figures, reference numerals refer to the same or equivalent parts of the disclosure throughout the several figures of the drawings.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. Hereinafter, exemplary embodiments will be described in detail with reference to the accompanying drawings.

The inventors of the present disclosure have made efforts to develop a method for preparing yaobian pottery capable of reproducing yaobian patterns. As a result, they have developed a method for preparing yaobian pottery according to the present disclosure. As used herein, the term pottery includes earthenware and porcelain. The pottery comprises clay, feldspar, limestone, silica, etc. as main components. The pottery is prepared by mixing the components at predetermined proportions, followed by shaping and baking.

Specifically, the present disclosure provides a method for preparing yaobian pottery comprising: 1) applying a first glaze composition on a surface of the pottery; 2) drying the potter; 3) applying a second glaze composition, wherein the second glaze composition is different from the first glaze composition, on a surface of the pottery, and 4) baking the pottery. The first glaze composition may comprise feldspar, limestone, dolomite, wollastonite, clay, alumina, kaolin, quartz porphyry, graphite, pine ash, titanium dioxide, pigment, bone ash and frit.

Preferably, the first glaze composition may comprise 75-85 parts by weight of limestone, 50-55 parts by weight of dolomite, 60-70 parts by weight of wollastonite, 75-85 parts by weight of clay, 30-40 parts by weight of alumina, 45-50 parts by weight of kaolin, 75-85 parts by weight of quartz porphyry, 15-25 parts by weight of graphite, 30-35 parts by weight of pine ash, 70-75 parts by weight of titanium dioxide, 45-50 parts by weight of a pigment, 10-15 parts by weight of bone ash and 30-35 parts by weight of frit, based on 100 parts by weight of feldspar. And, second glaze composition may comprise feldspar, limestone, dolomite, wollastonite, clay, pottery stone, alumina, kaolin, quartz porphyry, pine ash, titanium dioxide, pigment, bone ash, frit, stalactite, silica, cobalt oxide and petalite.

Preferably, the second glaze composition may comprise 15-25 parts by weight of limestone, 20-30 parts by weight of dolomite, 25-35 parts by weight of wollastonite, 70-80 parts by weight of clay, 10-20 parts by weight of pottery stone, 5-15 parts by weight of alumina, 45-55 parts by weight of kaolin, 35-45 parts by weight of quartz porphyry, 20-30 parts by weight of pine ash, 65-75 parts by weight of titanium dioxide, 70-80 parts by weight of a pigment, 20-30 parts by weight of bone ash, 55-65 parts by weight of frit, 10-20 parts by weight of stalactite, 35-45 parts by weight of silica, 10-20 parts by weight of cobalt oxide and 55-65 parts by weight of petalite, based on 100 parts by weight of feldspar.

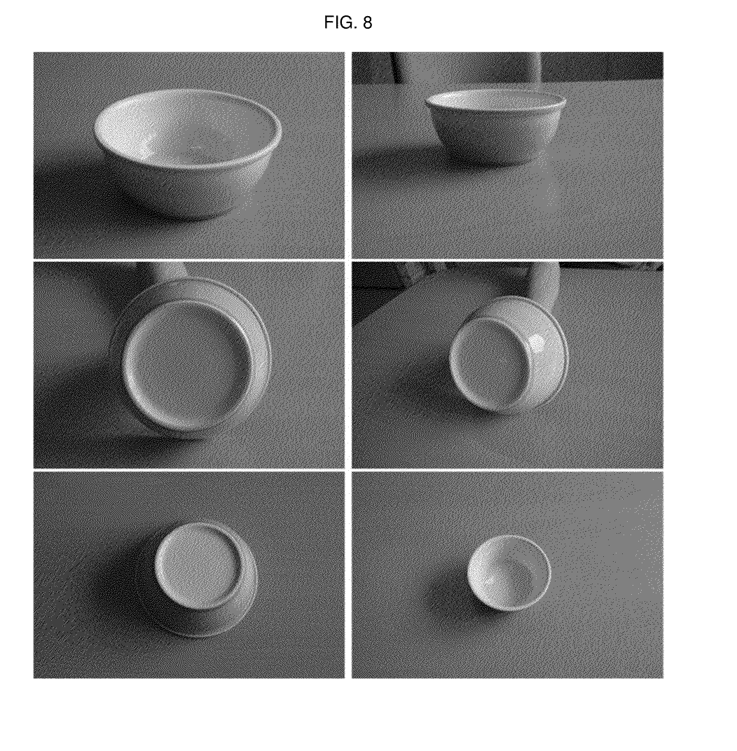

The yaobian pottery having regular yaobian patterns as shown in FIG. 8 can be prepared by applying the first glaze composition and the second glaze composition in the steps 2) and 5) and baking in the step 6). As seen from FIG. 8, the yaobian patterns are not dispersed irregular spots but are spots densely arranged with regular intervals. The interval between the spots may increase gradually from bottom to top of the side portion of the pottery.

These yaobian patterns result from the slight difference in the rate of hardening or flowing of the materials constituting the first glaze composition and the second glaze composition during the baking. When the compositions of the first glaze composition and the second glaze composition are outside the above-described ranges, voids may occur between the yaobian patterns or irregular yaobian patterns may be obtained. Titanium dioxide may be used to stably achieve and reproduce the yaobian patterns during the baking.

Specifically, the yaobian phenomenon may occur only on the side portion of the pottery where the first glaze composition and the second glaze composition are applied sequentially. Through repeated application of the first glaze composition and the second glaze composition and baking, the yaobian patterns may be attained reproducibly. The reproducibility of the yaobian patterns allow mass production of the yaobian pottery having the yaobian patterns and thus may contribute to the commercialization of the yaobian pottery.

The titanium dioxide included in the first glaze composition and the second glaze composition ensures that the yaobian phenomenon according to the present disclosure occurs stably with regular patterns at high temperature during the baking. That is to say, the titanium dioxide included in the first glaze composition and the second glaze composition may contribute to the occurrence of the yaobian phenomenon according to the present disclosure and ensure that the yaobian phenomenon occurs stably with regular patterns at high temperature during the baking of the other components contributing to the yaobian phenomenon, such as kaolin, quartz porphyry, pine ash, bone ash, frit, etc. The titanium dioxide may be in rutile, anatase or brookite from. The form of the titanium dioxide is not particularly limited as long as the yaobian phenomenon according to the present disclosure may occur stably. The rutile phase which is stable at high temperatures and the brookite phase which is stable at intermediate temperatures may ensure more stable patterns during the baking. When the first glaze composition is applied, the titanium dioxide and other components included in the first glaze composition may form regular spot- or drop-shaped patterns by forming crystals.

Specifically, the titanium dioxide may be included in an amount of 70-75 parts by weight in the first glaze composition, based on 100 parts by weight of feldspar, and in an amount of 65-75 parts by weight in the second glaze composition, based on 100 parts by weight of feldspar. If the content of the titanium dioxide is below the lowest limits, the expected effect of the titanium dioxide contributing to the yaobian phenomenon may not be fully achieved. And, if the content of the titanium dioxide exceeds the highest limits, the contents of the other components contributing to the yaobian phenomenon are restricted and irregular yaobian patterns may be obtained due to severe yaobian phenomenon. In addition, cracking of the glaze may occur after the baking.

When the pottery is applied with the first glaze composition and the second glaze composition containing titanium dioxide with the contents described above and baked, the regular yaobian patterns according to the present disclosure can be attained. The kaolin included in the first glaze composition and the second glaze composition may be a rock or clay mineral mainly composed of kaolinite. It may improve refractoriness of the pottery and contribute to the yaobian phenomenon.

The kaolin may be included in an amount of 45-50 parts by weight in the first glaze composition, based on 100 parts by weight of feldspar, and in an amount of 45-55 parts by weight in the second glaze composition, based on 100 parts by weight of feldspar. If the content of the kaolin is below the lowest limits, sufficient refractoriness of the pottery may not be achieved. And, if the content of the kaolin exceeds the highest limits, the contents of the other components contributing to the yaobian phenomenon are restricted.

The quartz porphyry included in the first glaze composition and the second glaze composition is a rock geologically belonging to the granite group. Also known as quartz monzonite, it is a rock in which quartz and feldspar are mixed densely. When added to the glaze compositions, the quartz porphyry may increase stability during direct heating by absorbing moisture and thus contribute to the yaobian phenomenon.

The quartz porphyry may be included in an amount of 75-85 parts by weight in the first glaze composition, based on 100 parts by weight of feldspar, and in an amount of 35-45 parts by weight in the second glaze composition, based on 100 parts by weight of feldspar. If the content of the quartz porphyry is below the lowest limits, sufficient stability may not be achieved during the baking. And, if the content of the quartz porphyry exceeds the highest limits, the contents of the other components contributing to the yaobian phenomenon are restricted.

The pine ash included in the first glaze composition may be obtained by completely combusting the branch of pine tree and may contribute to the yaobian phenomenon according to the present disclosure. The pine ash may be included in an amount of 30-35 parts by weight in the first glaze composition, based on 100 parts by weight of feldspar. If the content of the pine ash is below 30 parts by weight, the effect of contributing to the yaobian phenomenon may be insufficient. And, if the content of the pine ash exceeds 35 parts by weight, the contents of the other components contributing to the yaobian phenomenon are restricted.

The bone ash included in the first glaze composition and the second glaze composition may be obtained by burning and pulverizing cow bone and calcium phosphate and calcium carbonate may be main ingredients. It may contribute to the yaobian phenomenon according to the present disclosure.

The bone ash may be included in an amount of 10-15 parts by weight in the first glaze composition, based on 100 parts by weight of feldspar, and in an amount of 20-30 parts by weight in the second glaze composition, based on 100 parts by weight of feldspar. If the content of the bone ash is below the lowest limits, the effect of contributing to the yaobian phenomenon may be slight or irregular yaobian patterns may be obtained. And, if the content of the bone ash exceeds the highest limits, the contents of the other components contributing to the yaobian phenomenon are restricted.

The frit included in the first glaze composition and the second glaze composition provides heat resistance at high temperature, increases binding between the body and the glaze layer, and smoothens the surface. Specifically, heat-resistant refractory frit may be used and it may contribute to the yaobian phenomenon according to the present disclosure.

The frit may be included in an amount of 30-35 parts by weight in the first glaze composition, based on 100 parts by weight of feldspar, and in an amount of 55-65 parts by weight in the second glaze composition, based on 100 parts by weight of feldspar. If the content of the frit in the first glaze composition and the second glaze composition is below the lowest limits, breakage may occur during the baking and the effect of contributing to the yaobian phenomenon may be slight. And, if the content of the frit in the first glaze composition and the second glaze composition exceeds the highest limits, the contents of the other components contributing to the yaobian phenomenon are restricted.

Specifically, the frit may be lead-free alkaline frit or borate frit and the melting point of the frit may be 1250-1350° C. The frit is not particularly limited in composition as long as it can be used in the glaze of the pottery and is adequate for contributing to yaobian phenomenon according to the present disclosure. Specifically, it may comprise 12-18 parts by weight of Na₂O, 1.5-2.5 parts by weight of K₂O, 2-3 parts by weight of BaO, 0.5-1.0 part by weight of NiO, 0.5-1.0 part by weight of MnO, 0.5-1.2 parts by weight of CuO, 0.1-0.2 part by weight of CoO and 5-10 parts by weight of CaO, based on 100 parts by weight of SiO₂.

The components included in the first glaze composition and the second glaze composition other than titanium dioxide, kaolin, quartz porphyry, pine ash, bone ash and frit may also contribute to the yaobian phenomenon according to the present disclosure. If the contents of the other components in the first glaze composition and the second glaze composition are below the lowest limits, the effect of contributing to the yaobian phenomenon may be slight and irregular yaobian patterns may be obtained. And, if the contents of the other components in the first glaze composition and the second glaze composition exceed the highest limits, severe yaobian phenomenon and cracking of the glaze may occur.

After the application of the first glaze composition followed by the drying, the titanium dioxide and the other components of the first glaze composition may crystallize to form regular spots or drops. Then, after the application of the second glaze composition followed by the baking, the size or shape of the crystals may become uniform. In addition, the baking following the application of the first glaze composition and the second glaze composition may provide a smooth surface which cannot be achieved with the application of the first glaze composition only, and thus the effect of the glaze treatment can be maximized.

If the pottery is baked after sequentially applying the first glaze composition and the second glaze composition, the components contributing to the yaobian phenomenon are hardened during the baking or flow on the surface of the pottery until they are hardened at slightly different rates. As a result, the crystal spots may be densely arranged with regular intervals at the bottom portion, and the interval between the spots may increase gradually from bottom to top of the side portion of the pottery.

The first glaze composition and the second glaze composition may be prepared by mixing the components at the above-described proportions and then stirring. In the step 2), the bottom portion of the pottery may be covered by attaching an impermeable layer to the bottom portion of the pottery. The impermeable layer may comprise any material impermeable to the first glaze composition, without particular limitation. Specifically, impermeable paper may be attached to a support fixing the whole or bottom portion of the pottery to cover the bottom portion of the pottery.

After the bottom portion of the pottery is covered, the inside portion of the pottery may be fixed by any means as long as overflow of the first glaze composition to the inside portion of the pottery can be prevented. Specifically, a fixing pipette may be used to fix the inside portion of the pottery.

In the state where the inside portion of the pottery is fixed, the pottery may be immersed in the first glaze composition up to the upper end of the side portion of the pottery such that the first glaze composition is applied only on the side portion of the pottery. Since the pottery is immersed in the first glaze composition only up to the upper end of the side portion of the pottery in the state where the inside portion of the pottery is fixed, the first glaze composition is not applied on the inside portion. And, since the bottom portion of the pottery is covered with the impermeable layer, the first glaze composition is not applied on the bottom portion of the pottery. Accordingly, the first glaze composition is applied only on the side portion of the pottery.

After the first glaze composition is applied, the titanium dioxide and the other components of the first glaze composition may form crystals, resulting in regular spot- or drop-shaped patterns on the surface of the pottery. After the first glaze composition is applied only on the side portion of the pottery, the impermeable layer covering the bottom portion of the pottery may be removed. After the impermeable layer is removed, the pottery may be dried. Specifically, the drying maybe performed at room temperature.

After the drying, an impermeable layer may be formed on a support positioned at the outermost edge of the bottom portion forming boundary with the side portion of the pottery and fixing pottery. When the second glaze composition is applied after the impermeable layer is formed on the support, the second glaze composition may be applied on the whole surface of the pottery excluding the support. After the impermeable layer is formed on the support, the second glaze composition may be applied on the whole surface of the pottery by immersing the pottery in the second glaze composition.

As a result, only the second glaze composition is applied on the bottom portion and the inside portion of the pottery. And, on the side portion of the pottery, the first glaze composition and the second glaze composition are sequentially applied. After the baking, the yaobian patterns according to the present disclosure may be obtained.

The side portion of the pottery on which the first glaze composition and the second glaze composition are sequentially applied may have smoother surface as compared to when only the first glaze composition is applied and, as a result, the crystals formed by the titanium dioxide may be arranged more regularly. Also, since the first glaze composition and the second glaze composition are sequentially applied on the side portion of the pottery and only the second glaze composition is applied on the bottom and inside portions of the pottery, the pattern and color of the side portion may be different from those of the bottom and inside portions.

That is to say, the color of the bottom portion the pottery on which only the second glaze composition is applied may be different from the color of the side portion of the pottery on which the first glaze composition and the second glaze composition are applied. Also, the color of the side portion of the pottery on which the first glaze composition and the second glaze composition are applied may be different from the color of the inside portion of the pottery on which only the second glaze composition is applied. Consequently, an effect of the color changing from the bottom to the side to the inside portions of the pottery may be achieved. The difference in the color of the three portions may provide a stereoscopically changing aesthetic sensation.

After the second glaze composition is applied, the pottery may be baked. After the baking, adhesively of the applied first and second glaze compositions to the pottery may be further enhanced. In addition, the strength and durability of the pottery may be improved and the first glaze composition and the second glaze composition may be hardened.

Specifically, the baking may be performed at 1250-1350° C. If the baking temperature is below 1250° C., the strength of the pottery may decrease, water content may increase, the second glaze composition may not be hardened enough, and the strength and durability of the pottery may not be sufficiently improved. And, if the baking temperature is above 1350° C., the quality of the finally prepared pottery may be not good, the applied glaze compositions may be discolored, and the cost for maintaining high temperature may increase excessively.

After the baking, the pottery may be cooled at room temperature. Specifically, a support may be formed such that the pottery may be fixed and supported in spite of external pressure or force after the cooling.

The method for preparing yaobian pottery according to the present disclosure as described above may allow the reproductive production of the yaobian pottery having regular yaobian patterns. The change in color of the pottery from the bottom to the side and to the inside portions may provide a stereoscopic aesthetic sensation. The present disclosure also provides yaobian pottery prepared by the method for preparing yaobian pottery according to the present disclosure, having yaobian patterns on the side portion where the first glaze composition and the second glaze composition are doubly.

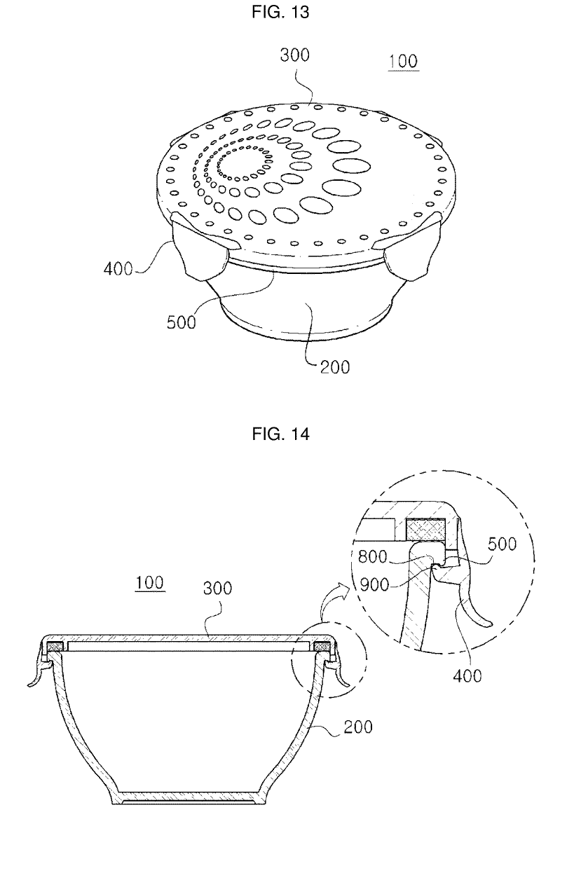

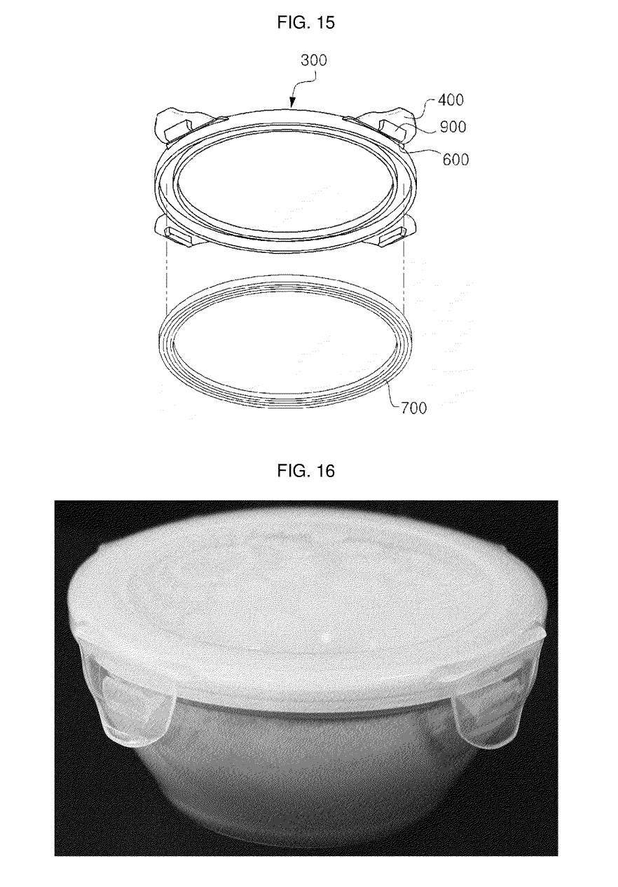

The present disclosure also provides a locking-type airtight container 100 using yaobian pottery comprising: a body 200 an upper portion of which is open; a lid 300 covering the upper portion; and a locking means 400 coupled to each side portion of the lid, wherein the body 200 has an edge 500 surrounding the outer circumference of the upper portion of the body 200, the locking means 400 is coupled by a hinge 600, and the body 200 and the edge 500 are the yaobian pottery according to the present disclosure. FIGS. 13-15 show a locking-type airtight container according to an exemplary embodiment of the present disclosure. The lid 300 is not particularly limited as long as it can cover the yaobian pottery. Any type of lid used as a lid in the related art may be used.

The locking means 400 may be rotatably coupled by the hinge 600. The lid 300 may have a packing 700 for sealing the inside of the body formed on the portion brought into contact with the upper portion of the body when the upper portion is covered. The packing may comprise any material that can adequately seal the locking-type airtight container, without particular limitation. Any material used as a packing in the related art may be used.

The edge 500 may have a coupling assisting groove 800 for coupling with the locking means 400 formed on the lower portion thereof, and the locking means may comprise a coupling rack 900 for coupling with the coupling assisting groove 800. Since the coupling assisting groove 800 formed on the lower portion of the edge 500 and the coupling rack 900 provided on the lower portion of the locking means 400 engaged with each other when the upper portion of the locking-type airtight container is covered, the lid may be prevented from being easily detached from the body. Accordingly, the locking-type airtight container using yaobian pottery according to the present disclosure may be used to store food and food ingredients for a long period of time.

### EXAMPLES

An exemplary embodiment of the present disclosure will be described in detail. However, the present disclosure may be otherwise variously embodied without being limited to the example.

### Example

### Preparation of Yaobian Pottery

Petalite, clay, feldspar, limestone, silica, etc. were mixed to prepare a pottery body. A first glaze composition was prepared by mixing and stirring 80 parts by weight of limestone, 53 parts by weight of dolomite, 67 parts by weight of wollastonite, 80 parts by weight of clay, 33 parts by weight of alumina, 47 parts by weight of kaolin, 80 parts by weight of quartz porphyry, 20 parts by weight of graphite, 33 parts by weight of pine ash, 73 parts by weight of titanium dioxide, 47 parts by weight of a pigment, 13 parts by weight of bone ash and 33 parts by weight of frit, based on 100 parts by weight of feldspar. And, a second glaze composition was prepared by mixing and stirring 20 parts by weight of limestone, 25 parts by weight of dolomite, 30 parts by weight of wollastonite, 75 parts by weight of clay, 15 parts by weight of pottery stone, 10 parts by weight of alumina, 50 parts by weight of kaolin, 40 parts by weight of quartz porphyry, 25 parts by weight of pine ash, 70 parts by weight of titanium dioxide, 75 parts by weight of a pigment, 25 parts by weight of bone ash, 60 parts by weight of frit, 15 parts by weight of stalactite, 40 parts by weight of silica, 15 parts by weight of cobalt oxide and 60 parts by weight of petalite, based on 100 parts by weight of feldspar. The contents of the first glaze composition and the second glaze composition are summarized in Table 1.

Thereafter, waterproof impermeable paper which is impermeable to any solvent or solute was attached to a support positioned at the edge of the bottom portion of the pottery body so as to prevent penetration of any material to the bottom portion of the pottery. Then, after fixing the inside portion of the pottery body with a fixing pipette, the pottery body was immersed in a container holding the first glaze composition. The pottery body was immersed in the first glaze composition up to the side portion only such that the first glaze composition could not permeate to the inside portion. As a result, the first glaze composition was applied only on the side portion, not on the bottom and inside portions of the pottery body.

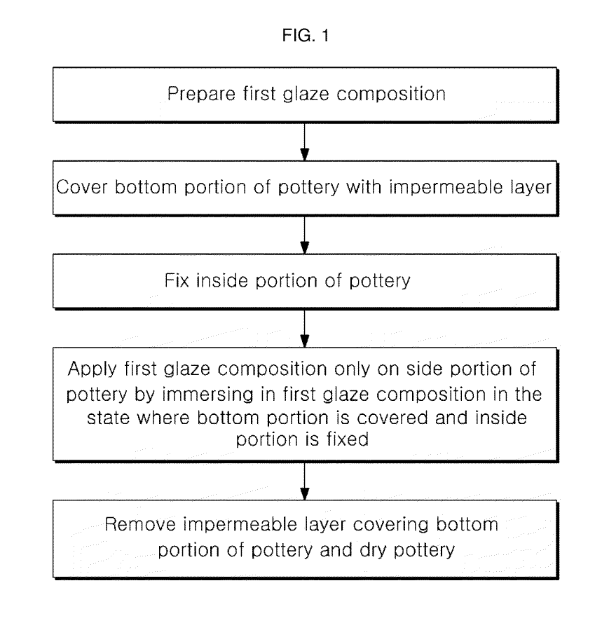

After the first glaze composition was applied only on the side portion, the impermeable paper covering the bottom portion of the pottery body was removed. Then, the pottery body was dried at room temperature. FIG. 1 describes the process of applying the first glaze composition.

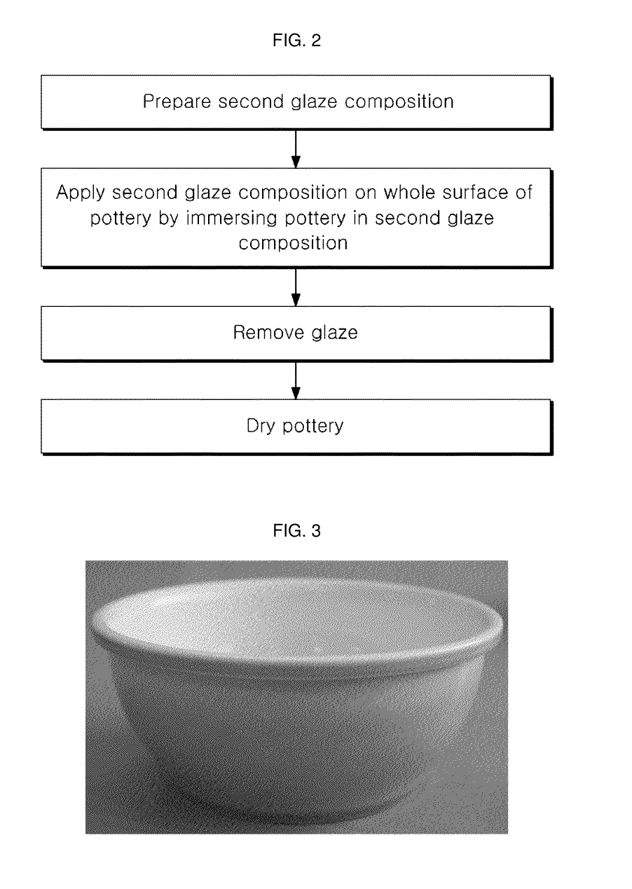

Thereafter, the second glaze composition was applied on the whole surface of the pottery body by immersing the pottery body in a container holding the second glaze composition. FIG. 2 describes a process of applying a second glaze composition.

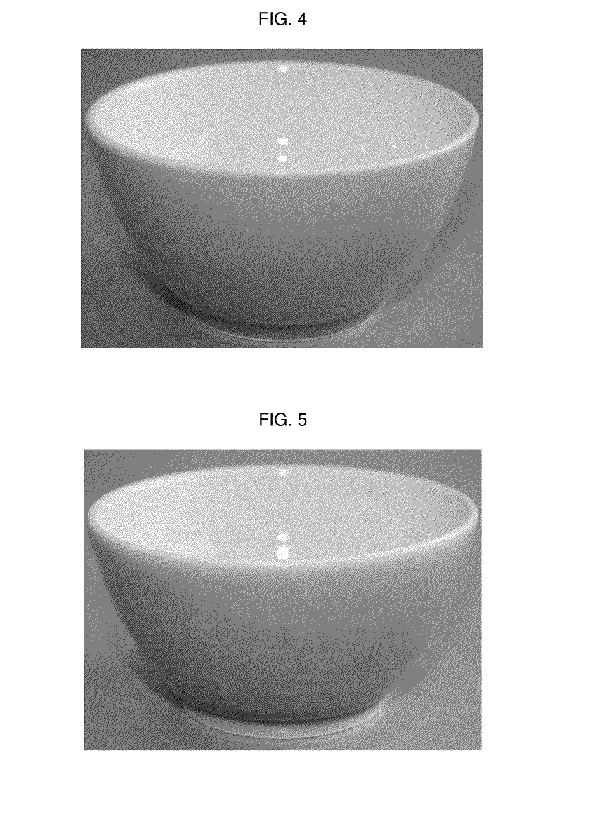

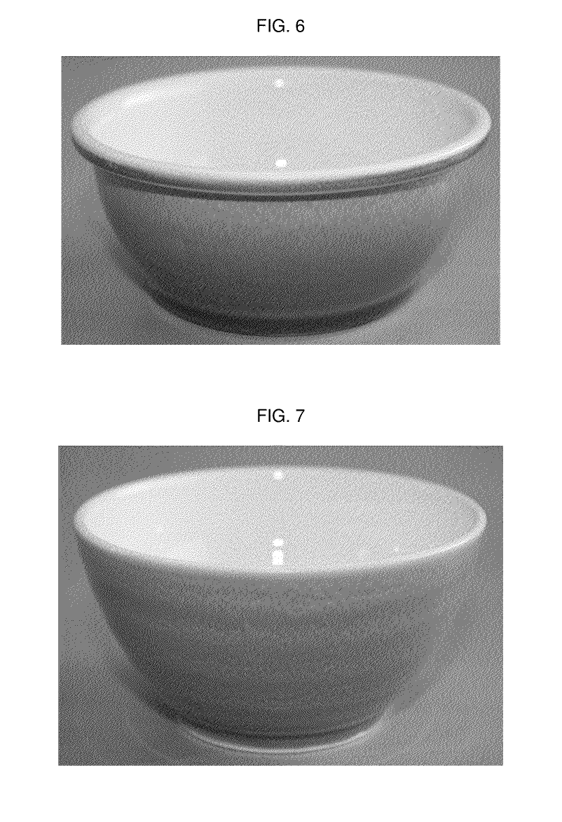

Thereafter, the pottery body was baked at 1300° C. in a kiln for baking pottery. After sufficient baking, the pottery body was taken out of the kiln and cooled at room temperature to obtain yaobian pottery. FIGS. 3-7 are photographs of the prepared yaobian pottery, and FIG. 8 shows photographs of the prepared yaobian pottery taken from different angles.

TABLE 1

| | First glaze composition | Second glaze composition |
|---|---|---|
| | (parts by weight) | (parts by weight) |
| Feldspar | 100 | 100 |
| Limestone | 80 | 20 |
| Dolomite | 53 | 25 |
| Wollastonite | 67 | 30 |
| Clay | 80 | 75 |
| Pottery stone | — | 15 |
| Alumina | 33 | 10 |
| Kaolin | 47 | 50 |
| Quartz porphyry | 80 | 40 |
| Graphite | 20 | — |
| Pine ash | 33 | 25 |
| Titanium dioxide | 73 | 70 |
| Pigment | 47 | 75 |
| Bone ash | 13 | 25 |
| Frit | 33 | 60 |
| Stalactite | 0 | 15 |
| Silica | 0 | 40 |
| Cobalt oxide | 0 | 15 |
| Petalite | 0 | 60 |

### COMPARATIVE EXAMPLES

### Comparative Example 1

### Preparation of Yaobian Pottery without Adding Titanium Dioxide

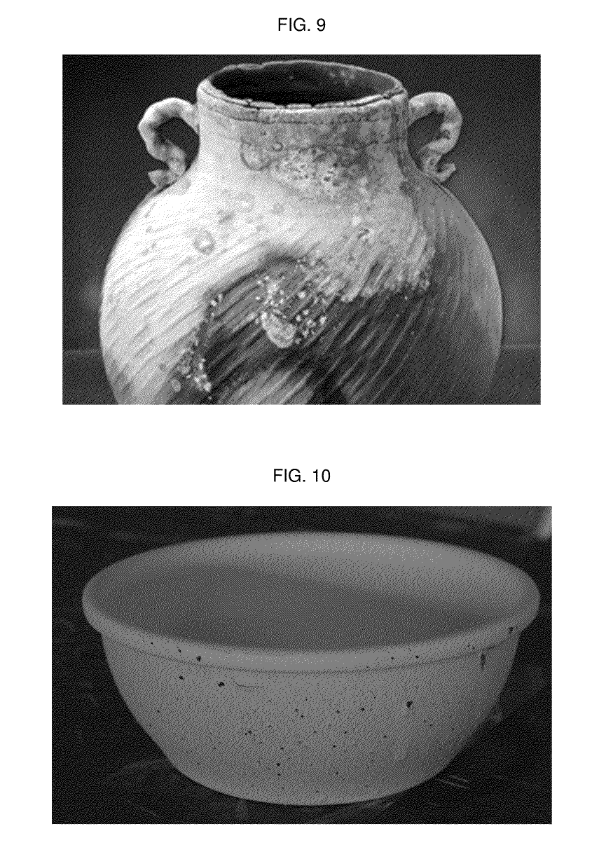

Yaobian pottery was prepared in the same manner as in Example except for not adding titanium dioxide to the first glaze composition and the second glaze composition. FIG. 9 is a photograph of the prepared pottery.

### Comparative Example 2

### Preparation of Yaobian Pottery with Decreased Amount of Titanium Dioxide

Yaobian pottery was prepared in the same manner as in Example except for adding 40 parts by weight of titanium dioxide to the first glaze composition and adding 30 parts by weight of titanium dioxide to the second glaze composition. FIG. 10 is a photograph of the prepared pottery.

### Comparative Example 3

### Preparation of Yaobian Pottery with Increased Amount of Titanium Dioxide 1

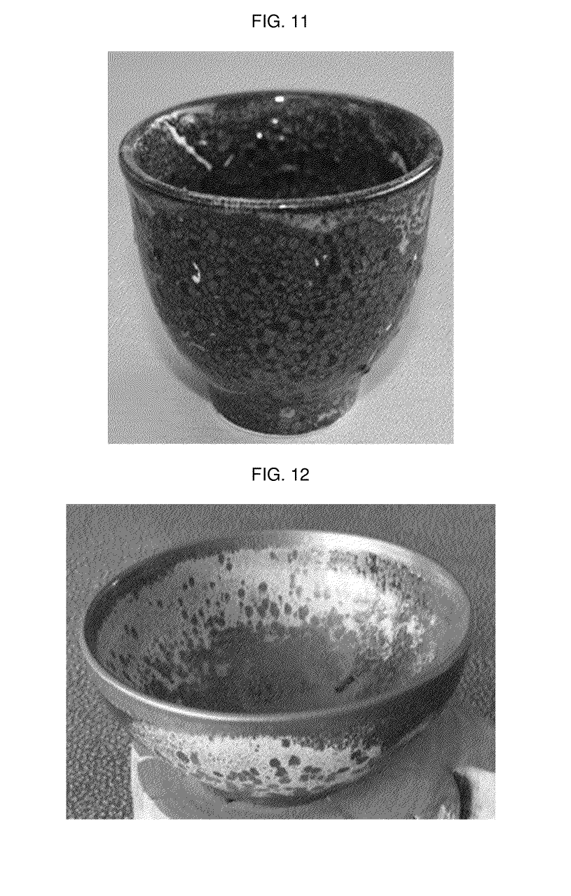

Yaobian pottery was prepared in the same manner as in Example except for adding 82 parts by weight of titanium dioxide to the first glaze composition and adding 80 parts by weight of titanium dioxide to the second glaze composition. FIG. 11 is a photograph of the prepared pottery.

### Comparative Example 4

### Preparation of Yaobian Pottery with Increased Amount of Titanium Dioxide 2

Yaobian pottery was prepared in the same manner as in Example except for adding 87 parts by weight of titanium dioxide to the first glaze composition and adding 85 parts by weight of titanium dioxide to the second glaze composition. FIG. 12 is a photograph of the prepared pottery.

### Preparation Example

### Preparation of Locking-Type Airtight Container Using Yaobian Pottery Prepared in Example

A locking-type airtight container was prepared using the yaobian pottery prepared in Example and further providing a lid that can be coupled with the upper portion of the pottery for covering the pottery. FIGS. 13-16 show the prepared locking-type airtight container.

### TEST EXAMPLE

### Test Example 1

### Comparison of Yaobian Patterns Depending on Presence or Absence of Titanium Dioxide

The pottery prepared in Example using the glaze compositions comprising titanium dioxide and that prepared in Comparative Example 1 using the glaze compositions without titanium dioxide were compared visually. The result can be seen from FIG. 8 and FIG. 9.

The pottery prepared in Comparative Example 1 had irregular and ugly patterns which can be hardly seen as yaobian patterns (see FIG. 9). In contrast, the pottery prepared in Example showed regular, reproducible patterns (see FIG. 8). The yaobian patterns result from the crystals formed as titanium dioxide and other components form crystals of regular drop or spot shape. Accordingly, it was verified that yaobian pottery having regular yaobian patterns can be prepared by adding titanium dioxide according to the present disclosure.

### Test Example 2

### Comparison of Yaobian Patterns Depending on Content of Titanium Dioxide

The pottery prepared in Example and those prepared in Comparative Examples 2-4 using the glaze compositions of different titanium dioxide contents were compared visually. The result can be seen from FIG. 8 and FIGS. 10-12.

The pottery prepared in Example had regular patterns from top to bottom of the side portion of the pottery (see FIG. 8). That is to say, the top of the side portion had relatively disperse patterns of spots, which were relatively denser toward the bottom of the side portion. The change in patterns was not abrupt but gradual and showed regularity.

In contrast, the pottery prepared in Comparative Examples 2-4 had disperse yaobian patterns which showed little regularity. In addition to the irregularity, the pottery prepared in Comparative Example 2 showed discoloration and cracking of the glaze (see FIG. 10). And, the pottery prepared in Comparative Example 3 wherein the content of titanium dioxide is higher than that of Example showed irregular yaobian patterns (see FIG. 11). The pottery prepared in Comparative Example 4 wherein the content of titanium dioxide is higher than that of Comparative Example 3 showed ugly patterns which can be hardly seen as yaobian patterns (see FIG. 12).

Accordingly, it was verified that yaobian pottery having regular and reproducible yaobian patterns can be prepared when the yaobian pottery is prepared by the method for preparing yaobian pottery according to the present disclosure. The reproducibility of the yaobian patterns allows the commercialization of the yaobian pottery. Also, the change in colors from the bottom to the side to the inside portions of the pottery greatly improve a stereoscopic aesthetic sensation. Also, a locking-type airtight container prepared by further providing a locking-type lid covering the upper portion of the yaobian pottery to the yaobian pottery may be used to store food and food ingredients for a long period of time.

While the present disclosure has been described with respect to the specific embodiments, it will be apparent to those skilled in the art that various changes and modifications may be made without departing from the spirit and scope of the disclosure as defined in the following claims.

The invention claimed is:

1. A method for preparing yaobian pottery, comprising:
applying a first glaze composition on a surface of the pottery;
drying the pottery;
applying a second glaze composition, wherein the second glaze composition is different from the first glaze composition, on a surface of the pottery; and
baking the pottery.

2. The method for preparing yaobian pottery according to claim 1, wherein the first glaze composition comprises feldspar, limestone, dolomite, wollastonite, clay, alumina, kaolin, quartz porphyry, graphite, pine ash, titanium dioxide, pigment, bone ash and frit.

3. The method for preparing yaobian pottery according to claim 2, wherein the first glaze composition comprises 75-85 parts by weight of limestone, 50-55 parts by weight of dolomite, 60-70 parts by weight of wollastonite, 75-85 parts by weight of clay, 30-40 parts by weight of alumina, 45-50 parts by weight of kaolin, 75-85 parts by weight of quartz porphyry, 15-25 parts by weight of graphite, 30-35 parts by weight of pine ash, 70-75 parts by weight of titanium dioxide, 45-50 parts by weight of a pigment, 10-15 parts by weight of bone ash and 30-35 parts by weight of frit, based on 100 parts by weight of feldspar.

4. The method for preparing yaobian pottery according to claim 1, wherein the second glaze composition comprises feldspar, limestone, dolomite, wollastonite, clay, pottery stone, alumina, kaolin, quartz porphyry, pine ash, titanium dioxide, pigment, bone ash, frit, stalactite, silica, cobalt oxide and petalite.

5. The method for preparing yaobian pottery according to claim 4, wherein the second glaze composition comprises 15-25 parts by weight of limestone, 20-30 parts by weight of dolomite, 25-35 parts by weight of wollastonite, 70-80 parts by weight of clay, 10-20 parts by weight of pottery stone, 5-15 parts by weight of alumina, 45-55 parts by weight of kaolin, 35-45 parts by weight of quartz porphyry, 20-30 parts by weight of pine ash, 65-75 parts by weight of titanium dioxide, 70-80 parts by weight of a pigment, 20-30 parts by weight of bone ash, 55-65 parts by weight of frit, 10-20 parts by weight of stalactite, 35-45 parts by weight of silica, 10-20 parts by weight of cobalt oxide and 55-65 parts by weight of petalite, based on 100 parts by weight of feldspar.

6. The method for preparing yaobian pottery according to claim 1, wherein the baking is performed at 1250-1350° C.

7. A method for preparing yaobian pottery, comprising:
preparing a first glaze composition and a second glaze composition;
applying the first glaze composition only on the side portion of the pottery by immersing the pottery in the first glaze composition up to the upper end of the side portion of the pottery in the state where the bottom portion of the pottery is covered with an impermeable layer and the inside portion of the pottery is fixed;
removing the impermeable layer covering the bottom portion of the pottery;
drying the pottery;
applying the second glaze composition on the whole surface of the pottery by immersing the pottery in the second glaze composition; and
baking the pottery.

8. The method for preparing yaobian pottery according to claim 7, wherein the first glaze composition comprises feldspar, limestone, dolomite, wollastonite, clay, alumina, kaolin, quartz porphyry, graphite, pine ash, titanium dioxide, pigment, bone ash and frit.

9. The method for preparing yaobian pottery according to claim 8, wherein the first glaze composition comprises 75-85 parts by weight of limestone, 50-55 parts by weight of dolomite, 60-70 parts by weight of wollastonite, 75-85 parts by weight of clay, 30-40 parts by weight of alumina, 45-50 parts by weight of kaolin, 75-85 parts by weight of quartz porphyry, 15-25 parts by weight of graphite, 30-35 parts by weight of pine ash, 70-75 parts by weight of titanium dioxide, 45-50 parts by weight of a pigment, 10-15 parts by weight of bone ash and 30-35 parts by weight of frit, based on 100 parts by weight of feldspar.

10. The method for preparing yaobian pottery according to claim 7, wherein the second glaze composition comprises feldspar, limestone, dolomite, wollastonite, clay, pottery stone, alumina, kaolin, quartz porphyry, pine ash, titanium dioxide, pigment, bone ash, frit, stalactite, silica, cobalt oxide and petalite.

11. The method for preparing yaobian pottery according to claim 10, wherein the second glaze composition comprises 15-25 parts by weight of limestone, 20-30 parts by weight of dolomite, 25-35 parts by weight of wollastonite, 70-80 parts by weight of clay, 10-20 parts by weight of pottery stone, 5-15 parts by weight of alumina, 45-55 parts by weight of kaolin, 35-45 parts by weight of quartz porphyry, 20-30 parts by weight of pine ash, 65-75 parts by weight of titanium dioxide, 70-80 parts by weight of a pigment, 20-30 parts by weight of bone ash, 55-65 parts by weight of frit, 10-20 parts by weight of stalactite, 35-45 parts by weight of silica, 10-20 parts by weight of cobalt oxide and 55-65 parts by weight of petalite, based on 100 parts by weight of feldspar.

12. The method for preparing yaobian pottery according to claim 7, wherein the baking is performed at 1250-1350° C.

13. A method for preparing yaobian pottery, comprising:
preparing a first glaze composition, wherein the first glaze composition comprises 75-85 parts by weight of limestone, 50-55 parts by weight of dolomite, 60-70 parts by weight of wollastonite, 75-85 parts by weight of clay, 30-40 parts by weight of alumina, 45-50 parts by weight of kaolin, 75-85 parts by weight of quartz porphyry, 15-25 parts by weight of graphite, 30-35 parts by weight of pine ash, 70-75 parts by weight of titanium dioxide, 45-50 parts by weight of a pigment, 10-15 parts by weight of bone ash and 30-35 parts by weight of frit, based on 100 parts by weight of feldspar;
preparing a second glaze composition, wherein the second glaze composition comprises 15-25 parts by weight of limestone, 20-30 parts by weight of dolomite, 25-35 parts by weight of wollastonite, 70-80 parts by weight of clay, 10-20 parts by weight of pottery stone, 5-15 parts by weight of alumina, 45-55 parts by weight of kaolin, 35-45 parts by weight of quartz porphyry, 20-30 parts by weight of pine ash, 65-75 parts by weight of titanium dioxide, 70-80 parts by weight of a pigment, 20-30 parts by weight of bone ash, 55-65 parts by weight of frit, 10-20 parts by weight of stalactite, 35-45 parts by weight of silica, 10-20 parts by weight of cobalt oxide and 55-65 parts by weight of petalite, based on 100 parts by weight of feldspar;
applying the first glaze composition only on the side portion of the pottery by immersing the pottery in the first glaze composition up to the upper end of the side portion of the pottery in the state where the bottom portion of the pottery is covered with an impermeable layer and the inside portion of the pottery is fixed;
removing the impermeable layer covering the bottom portion of the pottery;
drying the pottery;
applying the second glaze composition on the whole surface of the pottery by immersing the pottery in the second glaze composition; and
baking the pottery at 1250-1350° C.
